(19) United States
(12) Patent Application Publication
(10) Pub. No.: US 2011/0313849 A1
(43) Pub. Date: Dec. 22, 2011

(54) METHOD AND SYSTEM FOR EFFECTIVE MARKET RESEARCH

(76) Inventors: Klaus Brueck, Nuernberg (DE); Stephan Knaeble, Nuernberg (DE); Brian Dinicola, Monroe Twp, NJ (US)

(21) Appl. No.: 12/818,855

(22) Filed: Jun. 18, 2010

(51) Int. Cl. G06Q 30/00; G01S 3/80; H04M 3/42

(52) U.S. Cl. 705/14.45; 455/414.1; 235/375; 367/118

(57) ABSTRACT

To assess the effectiveness of advertising campaigns and channels, a portable user appliance is provided to each of a plurality of panel members. Each device includes a scanning module for scanning and storing a UPC code for each product purchased by a corresponding panel member, a processor, a memory, a user-interface, and a communication interface operative to transfer information stored in memory to a central facility. Each device further includes a microphone and is operative to monitor an audio portion of at least one of a radio broadcast and a television broadcast. UPC codes and information corresponding to purchases made by each respective panel member are received from the portable user appliances, as are transmissions from which the identities of advertisements included in monitored audio portions can be determined. This information, along with information collected from the personal computers used by the panel members to view web pages and make online purchases, is associated with the demographic profile and/or identity of each corresponding panelist.

### BACKGROUND OF THE INVENTION

1. Field of the Invention

The present invention relates to the field of market research, and more particularly, to the tracking of media and advertising effectiveness.

2. Description of the Related Art

Manufacturers and sellers of products and providers of service make very large investments in communication and advertising to potential and existing consumers. These parties are constantly seeking the kind of feedback that will confirm that they are targeting the right market(s), that their marketing strategy is accessing these targeted markets, and that their advertising and promotional tactics are having the desired effect. Manufacturers and retailers turn to market research companies and consultancy firms who specialize in the gathering and analysis of the data needed to provide such feedback.

Market research companies and consultancy firms typically collect data directly from consumers and shoppers, analyze and interpret the collected data, and then sell that interpreted data in the form of reports or presentations. It is known, for example, to interview and/or survey television viewers and radio listeners to learn which advertisements they recall viewing on television or hearing over the radio in the recent past. The results of the interviews/surveys are then cumulated and analyzed. The frequency with which a particular advertisement is recalled is used to estimate the viewing (and/or listening) public's “awareness” of that advertisement. Conventional thinking provides that the more “aware” the public is, the more “effective” the particular marketing campaign is considered to be.

Because the aforementioned surveying and interviewing techniques typically examine only large media advertisement-awareness such as TV or radio, they do not account for other important media such as events, promotions, and the Internet. Also, most methods ask consumers to recall advertisements long after they have seen them and as a result, many consumers “over claim”, which means that they will say that they have recently seen advertisements that have not been broadcast via television or radio for quite some time. Consumers will most often over claim with respect to advertisements relating to heavily-advertised and well-recognized brands, such as Coke®, for example. To overcome the problem of over claiming, methods have been developed that include a “baseline” of over claimed awareness. Using regression modeling, these methods determine what percentage of claimed awareness is “over claim”, and then uses the over claim percentage as a baseline. Thus, for instance, if television awareness of Coke advertising was determined to be 60%, the “baseline approach” would recognize that “over claim” in determining the “true” awareness of the Coke advertising. Even if the baseline approach helps in identifying incremental awareness attributable to truly recent advertisements, many people will say that they saw a particular advertisement on large media (e.g., television) even if they did not in fact see it on television because, for example, it ran in print only.

In addition to the aforementioned “over-claim” problem, consumer surveying and/or interviewing techniques do not provide insight into how delivery of the advertising message may have translated into a purchasing decision. Among the questions which often remain unanswered are how many times the consumer heard the advertising message before making a purchasing decision, through which media channels and other outlets were they exposed to the message (and at what times), and how much time elapsed between exposure to the message and consummation of the purchase.

Seeking to resolve some of the aforementioned deficiencies, “Project Apollo” was designed to be a single source, national market research service based on Nielsen's Homescan® technology for measuring consumer purchase behavior, combined with Arbitron's Portable People Meter (“PPM”) system, measuring electronic media exposure. In January 2006, these two companies completed the deployment of a national pilot panel of more than 11,000 persons in 5,000 households. Individuals within the sample were given incentives to voluntarily carry the Arbitron PPM, a pager-sized device that collects the person's exposure to electronic media sources: broadcast television networks, cable networks, and network radio as well as audio-based commercials broadcast on these platforms. Consumer exposure to other media such as newspapers, magazines and circulars were collected through additional survey instruments. Project Apollo was terminated in February of 2008.

While Project Apollo was designed with the intention of being a single source, national market service, it suffered from several critical flaws which have heretofore remained unaddressed. A first of these flaws was a lack of commitment on the part of the individual members, which were expected to respond to surveys and questionnaires, enter detailed data relating to their purchases, to carry and operate the PPM device at all times, and to use specialized equipment in their homes to scan and upload UPC codes and other information relating to their purchases. A second flaw with Project Apollo is that there was no mechanism for measuring each panel member's actual exposure to advertisements delivered online (via personal computer) other than by questionnaires and surveys, allowing the “over-claim” problem to persist at least with respect to this marketing channel.

A need therefore exists for a system and method by which it is possible to identify the precise media channels through which a specific advertisement or advertising campaign is reaching a representative sample of the intended audience of consumers.

A further need exists for a system and method by which actual purchasing decisions and outcomes—whether online or via traditional retail channels—are taken into account to assess the effectiveness of a particular advertisement or advertising campaign.

Yet another need exists for a way to achieve a high level of cooperation and commitment from those members of the consuming public who will be relied upon as a “single source” to provide the purchasing and advertisement message exposure data needed to assess the effectiveness of an advertisement or advertising campaign.

### SUMMARY OF THE INVENTION

The aforementioned needs are addressed, and an advance is made in the art, by a method for collecting and analyzing information about the advertisements to which each of a group of panel members have been exposed—regardless of whether these were advertising messages were delivered to the panel members via broadcast media (e.g., television or radio), internet advertising, or printed media—as well as for tracking substantially all of the purchases, in at least a specified category, made by such panel members. The group of panel members may be selected, for example, based on conventional statistical sampling techniques, so as to represent an accurate socio-demographic model of a geographic region. An integrated and comprehensive approach is taken with respect to these panel members. That is, all media channels to which each member are being exposed are monitored in real-time, as are the purchases they are making. This “single source” approach is not susceptible to the problem of “over-claiming” because exposure to particular advertising message is determined by actual monitoring and observation, with little or no reliance upon the recollections of an interviewee being required.

A method for improving market research to understand effectiveness of an integrated advertising campaign comprises a step of providing each of a plurality of panel members with a single portable user appliance. Each device includes a scanning module for identifying a UPC code for each product purchased by a corresponding panel member, a processor, a memory for storing each identified UPC code, and a user-interface manipulable to enter an identity of a point of purchase corresponding to each identified UPC code. By way of illustrative example, the scanning module may comprise a conventional, laser-based bar code scanner integrated into a customized PDA device. Alternatively, however, a Smartphone utilizing, for example, the well known Google Android operating system, can be configured to execute a commercially available bar code scanner application. Such applications are adapted to analyze an image of the UPC captured with the Smartphone's built-in camera to derive the UPC code.

As will be readily appreciated by those skilled in the art, the user-interface of the portable user appliance may consist of an alphanumeric keypad, a touch screen, a voice-to-text interface, or any combination of these. It suffices to say that in addition to the UPC code of the product(s) purchased, the panel member may utilize the user interface of the device to enter such data as the name and location of the store where the product(s) were purchased, the date and time they were purchased, and any other relevant data which may be specified or requested. A Smartphone implementation of the portable user appliance is deemed to be advantageous and especially preferred because it can satisfy each panel member's own need for a mobile terminal device and thereby make it more likely that the panel member will have the device on his or her own person most or all of the time. It is far easier (and more natural) for a panel member to scan and upload the UPC information of each product individually as it is placed into the shopping cart at the grocery store, and such an operation is accommodated by a device carried by the user. A Smartphone implementation of the portable user appliance makes such an operation feasible, and avoids the prior art approach of having panel members scan their recent purchases in a continuous, batch process once they return home.

The portable user appliance is preferably configured with a communication interface to enable uploading of scanned UPC data and other information to a central location. If this interface is a wireless communication interface adapted, for example, to establish a link with a mobile network, or an IEEE 802.11 local area network, uploading of store purchase data may be in real-time or near-real time (e.g., while at the grocery store). The interface need not, however, be wireless, however. Indeed, the interface may be omitted altogether in favor of storing the data on a removable memory card transferable to a personal computer or other device relied upon to perform the uploading step.

A portable user appliance employed by an illustrative embodiment of the inventive method further includes a microphone and is operative to monitor an audio portion of at least one of a radio broadcast and a television broadcast. Since a Smartphone or other PDA device is already equipped with a microphone to implement telephonic communication, it will suffice to mention again that such devices may be readily adapted to perform the measuring and monitoring steps of the present invention. An illustrative implementation of the portable user appliance can be realized by a mobile phone running the Google Android operating system and an application adapted to periodically sample the audio input collected at the microphone, and to digitize and store these samples in memory for subsequent uploading to a central facility. In accordance with this embodiment, the samples received at the central facility are compared to a library of samples associated with television and audio broadcasts. Provided the panel member was carrying the portable user appliance or was reasonably close to it, a reliable determination can be made as to which broadcast the panel member was listening to (or watching) and, accordingly, as to which advertising messages the panel member was exposed.

A method for performing market research in accordance with the present invention further includes a step of receiving, in a first receiving step, UPC code information corresponding to purchases made by each respective panel member and uploaded from a corresponding portable user appliance, and, in a first associating step, associating UPC code information received during the first receiving step with at least one of a demographic profile and an identity of each respective panel member.

A method for performing market research in accordance with the present invention further includes, in a second receiving step, receiving from each portable user appliance, a transmission from which identities of advertisements included in monitored audio portions can be determined and, in a second associating step, associating at least one of the demographic profile and the identity of each respective panel member with advertisements identified from audio portions monitored by the corresponding portable user appliance.

A method for performing market research in accordance with the present invention further includes, in a third receiving step, receiving information from a personal computer used by a panel member to view Internet web pages containing advertisements and/or make online purchases. The information received from the personal computer is representative of at least one of advertisements seen and products purchased by a corresponding panel member. To this end, a web usage tracking application executing on the personal computer is adapted to initiate local storage of a URL corresponding to each web page visited by each user of the personal computer. In accordance with an exemplary embodiment of the present invention, the tracking application is further adapted to initiate periodic storage of data representative of a “screen shot” image of each web page visited, whereby it is possible to identify the particular advertisements seen by each user of the personal computer. Optionally, the tracking application is further adapted to initiate storage of an indication of when each web page was first viewed, from which indications an amount of time a user has been exposed to a particular web page and the content associated therewith can be derived.

A method for performing market research in accordance with the present invention further includes a step of periodically collecting, from respective personal computers used by at least one corresponding panel member, information corresponding to web sites visited by said at least one corresponding panel member and advertisements seen by said at least one corresponding panel member. To distinguish between two or more members of a household having access to the same personal computer, an illustrative embodiment of the present invention includes monitoring the proximity of a panel member's portable user appliance to the personal computer. If the panel member associated with the closest portable user appliance is not logged into the personal computer, the user of the personal computer is requested by a screen pop-up to confirm his or her identity by at least one of retrieving and energizing his or her portable user appliance and repeating a log-in process. The proximity measurements may be made, for example, via a signal power measurement application executing on each portable user appliance, on each adjunct device, or a combination thereof. In the former regard, the adjunct device may be configured to transmit a beacon signal at a predetermined channel and power frequency, and to periodically poll the portable user appliance(s) of a household. In response to the polling operation, each portable user appliance will transmit a signal representative of the received power level of the beacon signal.

A method for performing market research further includes providing an adjunct device, associated with at least one television set within the household of a panel member, adapted to monitor the proximity of a panel member's portable user appliance to the television set. If a proximity measurement exceeds a predetermined threshold, audio monitoring functions are performed by the adjunct device rather than the portable user appliance, thereby promoting power conservation and extending the battery life of the portable user appliance.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limits of the present invention, and wherein:

FIG. 1 is flow chart diagram illustrating an illustrative embodiment of a method of market research applied to a single source panel constituting a representative sample of consumers in order to understand the effectiveness of an integrated advertising campaign;

FIG. 2 is a flow chart diagram depicting an exemplary sequence of steps for capturing product purchase information from members of a single source panel in accordance with one aspect of the illustrative method of FIG. 1;

FIG. 3 is a flow chart depicting an exemplary sequence of steps for measuring broadcast advertising message exposure among members of a single source panel in accordance with another aspect of the illustrative method of FIG. 1;

FIG. 4 is a flow chart depicting an exemplary sequence of steps for measuring at least one of purchases and exposure to advertising messages during online shopping and browsing activity;

FIG. 5 is a block schematic diagram of a system for carrying out the method of FIG. 1 according to an embodiment of the present invention;

FIG. 6 is a block diagram depicting, in greater detail, the functional components of a portable user appliance for collecting product purchase and multi-media exposure according to an embodiment of the present invention;

FIG. 7 is a block diagram depicting an optional first adjunct device for distinguishing between two or more members of a household having access to the same personal computer; and

FIG. 8 is a block diagram depicting an optional second adjunct device which can be associated with one or more television sets or other media access devices and which is adapted to promote power conservation and extension of portable user appliance battery life by performing certain portable user appliance monitoring functions when the portable user appliance(s) (and corresponding panel member) are nearby.

### DETAILED DESCRIPTION OF THE INVENTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

The term “panel member” as used herein refers to a person whose purchasing activity and exposure to media and online advertising messages is being monitored—whether by electronic, survey or other means—in order to obtain a single source view of a representative sample of consumers that will provide insight into the effectiveness of an advertising message or choice of media channel to deliver that message.

The term “household” as used herein is to be broadly construed to include family members, a family living at the same residence, a group of persons related or unrelated to one another living at the same residence, and a group of persons (of which the total number of unrelated persons does not exceed a predetermined number) living within a common facility, such as a fraternity house, an apartment or other similar structure or arrangement, as well as such common residence or facility.

The term “data” as used herein means any indicia, signals, marks, symbols, domains, symbol sets, representations, and any other physical form or forms representing information, whether permanent or temporary, whether visible, audible, acoustic, electric, magnetic, electromagnetic or otherwise manifested. The term “data” as used to represent predetermined information in one physical form shall be deemed to encompass any and all representations of corresponding information in a different physical form or forms.

The terms “media data” and “media” as used herein mean data which is widely accessible, whether over-the-air, or via cable, satellite, network, internetwork (including the Internet), print, displayed, distributed on storage media, or by any other means or technique that is humanly perceptible, without regard to the form or content of such data, and including but not limited to audio, video, audio/video, text, images, animations, databases, broadcasts, displays (including but not limited to video displays, posters and billboards), signs, signals, web pages, print media and streaming media data.

The term “media channel” as used herein refers to the particular path by which a panel member is exposed to the media.

The term “research data” as used herein means data comprising (1) data concerning usage of media data, (2) data concerning exposure to media data, and/or (3) market research data.

The term “presentation data” as used herein means media data, content other than media data or a message to be presented to a user.

The term “ancillary code” as used herein means data encoded in, added to, combined with or embedded in media data to provide information identifying, describing and/or characterizing the media data, and/or other information useful as research data.

The term “reading” as used herein means a process or processes that serve to recover research data that has been added to, encoded in, combined with or embedded in, media data.

The term “database” as used herein means an organized body of related data, regardless of the manner in which the data or the organized body thereof is represented. For example, the organized body of related data may be in the form of one or more of a table, a map, a grid, a packet, a datagram, a frame, a file, an e-mail, a message, a document, a report, a list or in any other form.

The term “network” as used herein includes both networks and internetworks of all kinds, including the Internet, and is not limited to any particular network or inter-network.

The terms “first”, “second”, “primary” and “secondary” are used to distinguish one element, set, data, object, step, process, activity or thing from another, and are not used to designate relative position or arrangement in time, unless otherwise stated explicitly.

The terms “coupled”, “coupled to”, and “coupled with” as used herein each mean a relationship between or among two or more devices, apparatus, files, circuits, elements, functions, operations, processes, programs, media, components, networks, systems, subsystems, and/or means, constituting any one or more of (a) a connection, whether direct or through one or more other devices, apparatus, files, circuits, elements, functions, operations, processes, programs, media, components, networks, systems, subsystems, or means, (b) a communications relationship, whether direct or through one or more other devices, apparatus, files, circuits, elements, functions, operations, processes, programs, media, components, networks, systems, subsystems, or means, and/or (c) a functional relationship in which the operation of any one or more devices, apparatus, files, circuits, elements, functions, operations, processes, programs, media, components, networks, systems, subsystems, or means depends, in whole or in part, on the operation of any one or more others thereof.

The terms “communicate,” “communicating” and “communication” as used herein include both conveying data from a source to a destination, and delivering data to a communications medium, system, channel, network, device, wire, cable, fiber, circuit and/or link to be conveyed to a destination. The term “communications” as used herein includes one or more of a communications medium, system, channel, network, device, wire, cable, fiber, circuit and link.

The term “processor” as used herein means processing devices, apparatus, programs, circuits, components, systems and subsystems, whether implemented in hardware, software or both, and whether or not programmable. The term “processor” as used herein includes, but is not limited to one or more computers, hardwired circuits, signal modifying devices and systems, devices and machines for controlling systems, central processing units, programmable devices and systems, field programmable gate arrays, application specific integrated circuits, systems on a chip, systems comprised of discrete elements and/or circuits, state machines, virtual machines, data processors, processing facilities and combinations of any of the foregoing.

The terms “memory”, “storage” and “data storage” as used herein mean one or more data storage devices, apparatus, programs, circuits, components, systems, subsystems, locations and storage media serving to retain data, whether on a temporary or permanent basis, and to provide such retained data.

The term “portable user appliance” (also referred to herein, for convenience, by the abbreviation “PUA”) as used herein means an electrical or non-electrical device capable of being carried by or on the person of a user or capable of being disposed on or in, or held by, a physical object (e.g., attaché, purse, clothing) capable of being carried by or on the user, and having at least one function of primary benefit to such user, including without limitation, a cellular telephone, a personal digital assistant (“PDA”), a Blackberry® device, a GPS device, a two-way radio, a personal communications device, a telematics device, a remote control device, a wristwatch, a portable data storage device (e.g., Thumb™ drive), a camera, a bar code scanner, and a keyless entry device, as well as any devices combining any of the foregoing or their functions.

The term “research device” as used herein shall mean (1) a portable user appliance configured or otherwise enabled to gather, store and/or communicate research data, or to cooperate with other devices to gather, store and/or communicate research data, and/or (2) a research data gathering, storing and/or communicating device.

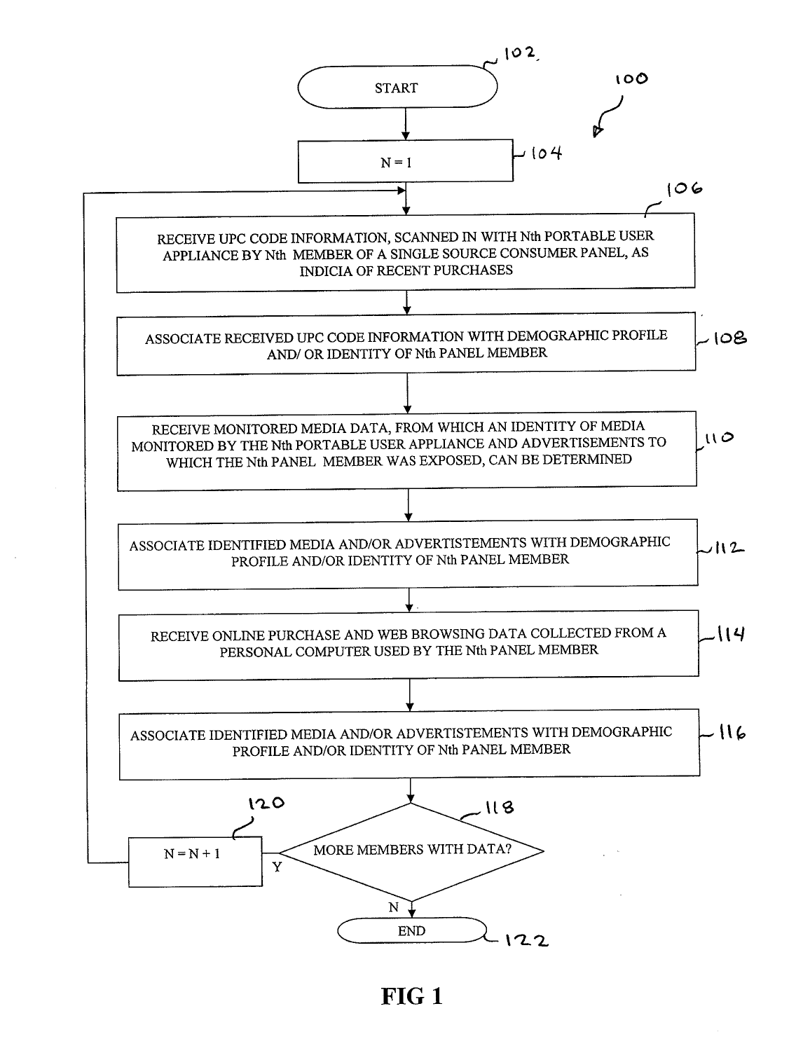

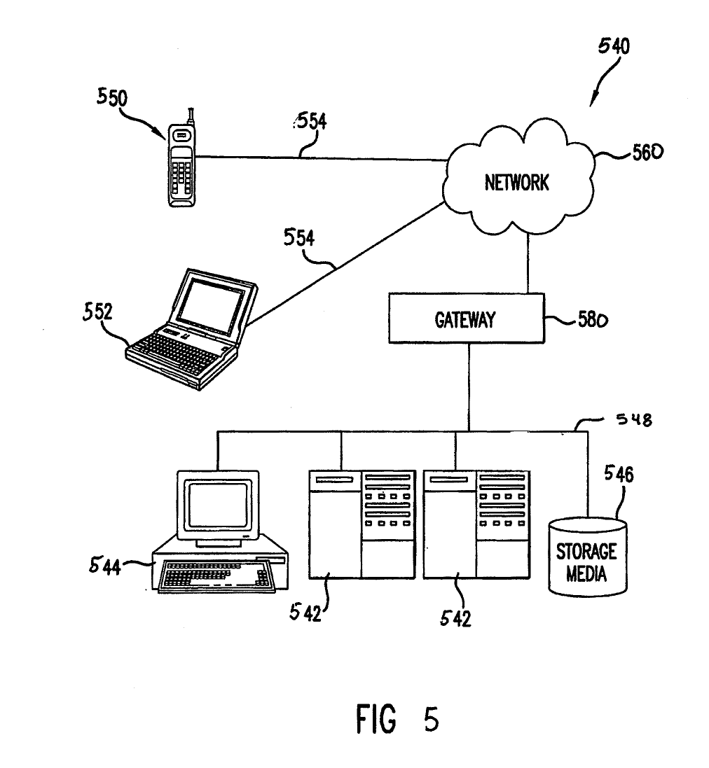

With initial reference to FIG. 1, an illustrative method for using a single source panel of consumers to improve market research and obtain an enhanced understanding of the effectiveness of an integrated advertising campaign will now be described. Each member of a panel receives a portable user appliance which, as will be described in greater detail later in connection with FIGS. 5-8, includes a scanning module for scanning and storing a UPC code for each product purchased by a corresponding panel member, a processor, a memory operatively associated with the processor for storing scanned UPC codes and other product purchase information, a user-interface, a microphone, and a communication interface operative to transfer information stored in the portable appliance's memory for delivery to a central facility. Each said portable user appliance is operable according to a first mode of operation to scan and store in memory UPC code of purchases made by a corresponding panel member and according to a second mode of operation to monitor an audio component of media to which the corresponding panel member is being exposed.

Process 100 is entered at block 102, whereupon market research information will be collected from each of N panel members commencing with an initial panel member (block 104). At block 106, UPC code information corresponding to recent purchases made by the initial panel member and captured using the scanning module of a portable user appliance is received at a central facility. The received UPC code information is associated at block 108 with the demographic profile and/or the identity of the initial panel member. In accordance with a single source panel implementation of the present invention, monitored media data from which an identity of media monitored by the initial panel member's portable user appliance can be determined is received at block 110. The monitored media data, or information derived therefrom, is associated with the demographic profile and/or identify of the initial panel member at block 112. Data collected by and/or from a personal computer used by the initial panel member, relating to online purchases and web browsing activity by the initial member, is received at block 114, and at block 116 this data is associated with the demographic profile and/or identity of the initial panel member. If there is an additional panel member from which data is to be collected at decision block 118, the process redirects at block 120 to block 106 and, when there are no other such additional panel members from whose portable user appliance data is to be collected, the process is passed by decision block 118 to termination block 122.

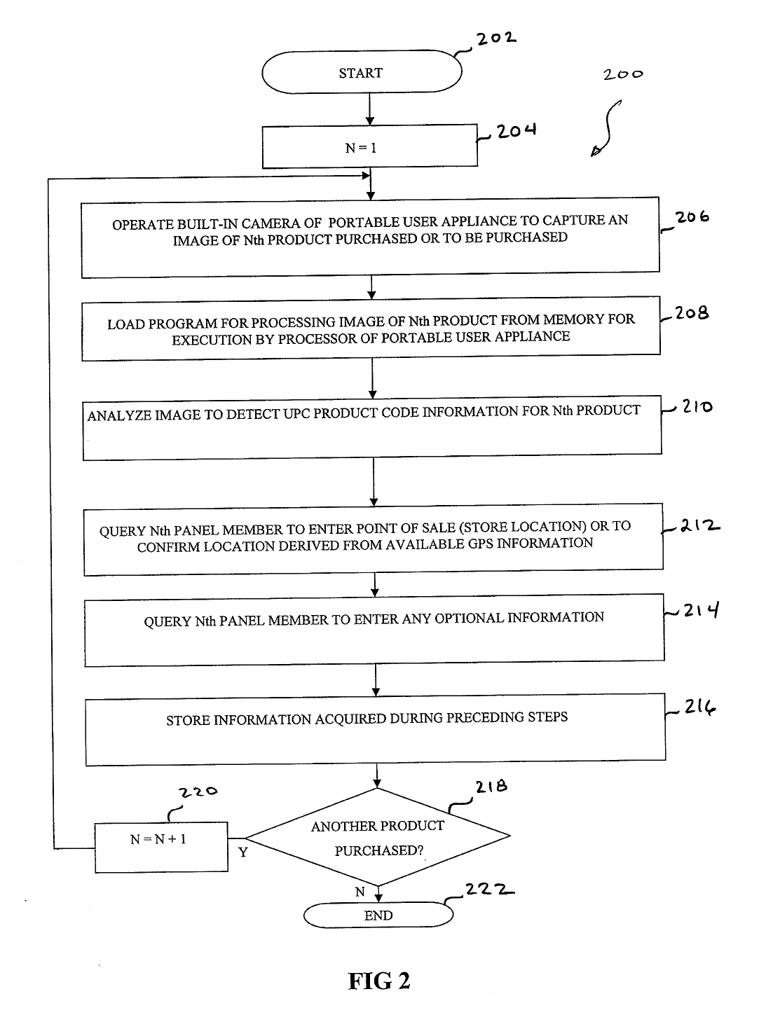

Turning now to FIG. 2, an exemplary sequence of steps for capturing product purchase information from members of a single source panel in accordance with one aspect of the illustrative method of FIG.1 will now be described. The process 200 commences at initial block 202 and passes to block 204 at which point a panel member initiates a purchase of at least one product N that is of a type which is the subject of market research. At block 206, the initial panel member operates a built-in camera of his or her portable user appliance to capture an image of the Nth product, which has either already been purchased or at some early phase of the selection and purchase process. At block 208, a program for processing the captured image is loaded and executed in order to analyze the image and detect the UPC product code information for the Nth product (block 210). At block 212, the panel member operating the portable user appliance to capture the product code information of the Nth product is queried to enter point of sale information (location of store where item is being or was purchased). Advantageously, available GPS or other location information available to the portable user appliance can be used to present a default store location or list of default store locations from which the panel member can choose. At block 214, the panel member is optionally queried to provide any additional information, and at block 216 the information captured and otherwise received by the portable user appliance is either stored locally for subsequent transfer (block 216) or, alternatively, transferred without further delay to a central storage analysis facility. The aforementioned process steps are repeated (blocks 218, 220) until there are no longer any products to scan, at which point the process passes from decision block 218 to termination block 222.

There in fact multiple solutions for implementing the capture of product purchase information. There is a single step solution which uses a scanner to capture the UPC information, and a display and user interface for presenting additional questions (price, etc) for every purchase action. Such a solution is contemplated by process 200. A first modified approach would be scanning, without asking any additional questions at the time of the scanning operation, followed by a request that the panel members respond to a survey or questionnaire to provide any missing information as, for example, via a personal computer connected to the internet. A second modified approach would be to simply have the panel member perform the scanning but no further input. Any of these are consistent with single panel market research using a portable user appliance in accordance with the present invention.

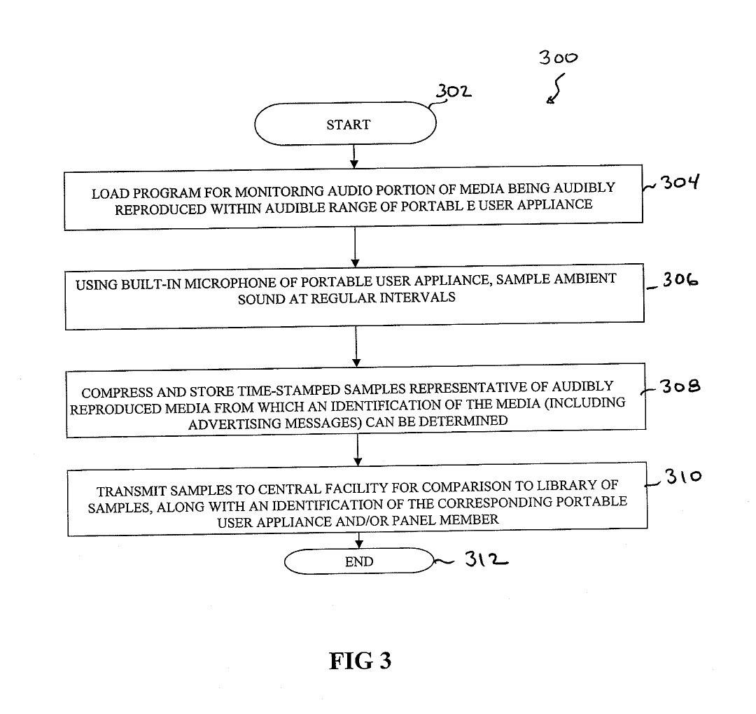

With reference now to FIG. 3, an exemplary sequence of steps for measuring broadcast advertising message exposure among members of a single source panel in accordance with another aspect of the illustrative method of FIG. 1 will now be described. The process, indicated generally at reference numeral 300, is entered at block 302 and proceeds to block 304 where an executable program for monitoring an audio component of media being audibly reproduced within audible range of a panel member's portable user appliance is loaded for execution by an onboard processor. At block 306, a microphone of the portable user appliance samples ambient sound at regular intervals, and at block 308, these samples are compressed and stored with appropriate time stamps. The samples are representative of audibly reproduced media from which an identification of the media (including advertising messages) being accessed by the corresponding panel member can be determined. At block 310, the compressed and stored samples are transmitted or otherwise provided to a central facility for respective comparison to a library of respective samples taken during corresponding time slots substantially concurrent with the time stamped samples according to a conventional sound matching technique. The process terminates when ambient sound is below a threshold of detectable acoustic energy, when the portable user appliance is too low on power to function, or when the unit is de-energized.

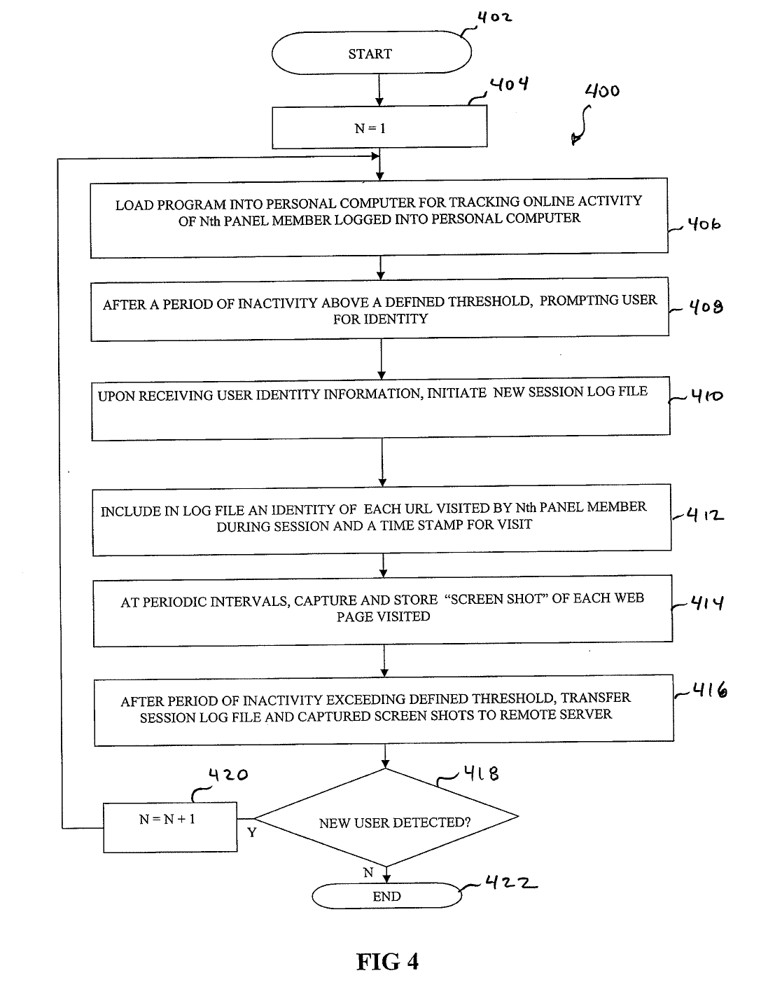

Turning now to FIG. 4, there is shown an exemplary sequence of steps for measuring at least one of a panel member's purchases and exposure to advertising messages during online shopping and browsing activity. Process 400 commences at block 402 for an initial panel member 404. At block 406, a program (which can include a log or script), is loaded into a personal computer to which the initial panel member has access. After an initial period of inactivity, the personal computer is configured to display a log-in message wherein the initial panel member is prompted to provide authentication information confirming his or her identity (block 408). In response to receiving the user identity/authentication information requested, a new session log is initiated (block 410), and each URL visited is logged and time stamped (block 412). Optionally, screen shot images of web pages visited by the panel member may be captured and stored under the direction of the tracking program (block 414), for subsequent collection by a remote server. After a period of inactivity exceeding a defined threshold, the session log file is terminated and subsequently transferred, along with any of the aforementioned “screen shots” to the remote server (block 416). If a new user logs in (blocks 418, 420), the process is re-entered at block 406, otherwise it ends at block 422.

Methods of using a portable user appliance and software running on a personal computer to collect consumer data from members of a single source panel in accordance with the teachings of the present invention may be implemented via a computer system, one embodiment of which is shown as element 540 in FIG. 5. In the illustrative embodiment of FIG. 5, system 540 is disposed at a central facility and comprises at least one server computer 542 coupled to at least one display computer 544 and at least one storage media 546. These components comprise a Local Area Network (LAN) or Wide Area Network (WAN) 548. At least one portable user appliance 550 is assigned to each panel member of a household and, in the illustrative embodiment of FIG. 5, is realized by a mobile telecommunication device such as a mobile telephone that is adapted to be coupled to the at least one server component by a wireless or terrestrial link indicated generally at reference numeral 554. Some or all members of a single source consumer panel may also have access to a personal computer 552 or other device within the household configured to access the Internet and display web pages.

As will be described in greater detail shortly, each portable user appliance 550 and personal computer 552 associated with a member of a single source panel comprises at least one program (not shown) executable by an on-board processor and is configured to receive input associated with a panel member's exposure to media and any advertising messages embodied therein. Single source panel participant devices as devices 550 and 552 are capable of generating communications via links 554 relating to the aforementioned input. Devices 550 and 552 may communicate with the at least one server computer 542 via any means known in the art and using any convenient transmission protocol. It is contemplated by the inventors herein, however, that portable user appliance 550 may be equipped with a wireless communication interface to allow data to be transmitted at regular intervals, which is one reason why a mobile terminal implementation of the portable user appliance is especially preferred. Another is that by implementing portable user appliance 550 in the form of a ubiquitous, feature-rich device capable of executing multiple programs simultaneously, such as newer versions of the Apple ® I-Phone or phones utilizing the Google Android operating system, there is a high likelihood that members of a single source panel of consumers will carry the devices with them most or all of the time and become well-acquainted with their use. Such a high level of integration into the daily lives of each panel member is deemed by the inventors herein to be critical to the implementation of a single source consumer panel.

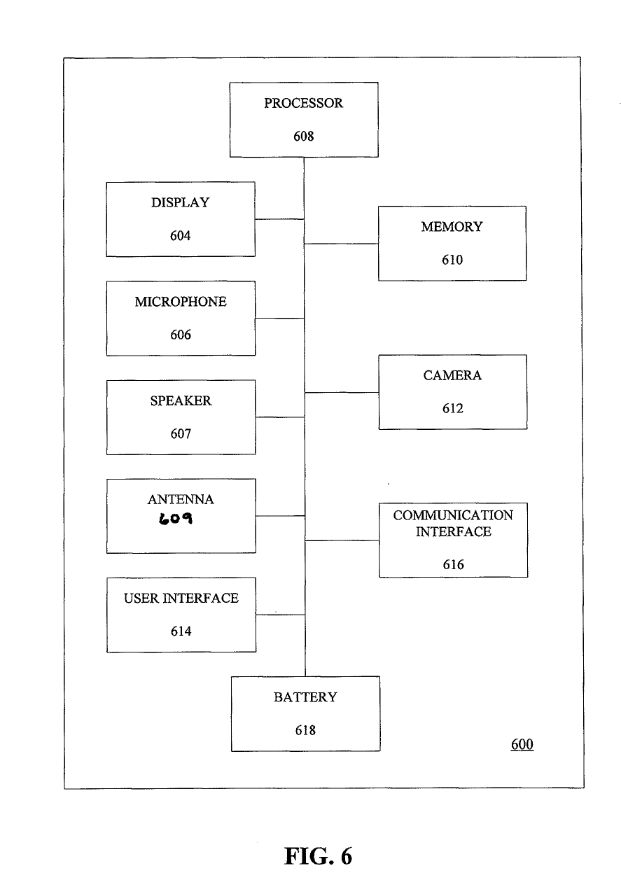

Turning now to FIG. 6, it will be seen that a portable user appliance 600 constructed in accordance with an illustrative, smartphone embodiment of the present invention includes a housing (not shown), a display 604, a microphone 606 and speaker 607, an on-board processor 608, a memory 610 operatively associated with processor 608, an antenna 609, a built in camera 612, a user interface 614 (which may include any or all of a conventional alphanumeric keypad, a touch sensitive display overlay, and a speech recognition module), a communication interface 616, and a battery 618 for supplying power to the device. Communication interface 616 preferably includes, in addition to a traditional GSM or CDMA RF transceiver (not shown), at least one of an IEEE 802.11 and Bluetooth wireless interface, and also a USB interface. It is expected that such functionality, in addition to maintaining a high level of appeal responsive to the demands and expectations of panel members, will make it easier to retrieve/transfer data from the portable user appliance to the central facility for the subsequent processing and analysis that is the object of single source market research in accordance with the present invention.

A first program, adapted to be executed by processor 608 of the portable user appliance in accordance with an illustrative embodiment of the present invention, is adapted to implement the capture of audio samples using microphone 606, as well as subsequent processing of the samples for subsequent storage in memory 610 of information derived therefrom for subsequent transfer using communication interface 616. The audio samples include samples of an audio component of radio and/or television broadcasts (whether via an over-the-air, cable, or internet channel) accessed by the member of the single source panel to whom portable user appliance 600 is assigned. There are a variety of ways for performing the sampling/media monitoring function required for practicing the methods of conducting single source panel research in accordance with the teachings of the present invention.

Portable devices known as the MediaWatch distributed by GfK Telecontrol AG (Kriegstetten, Switzerland) and similar devices distributed by GM Eurisko (Milan, Italy) are implemented in a very compact form factor such, as a wristwatch, and use very efficient algorithms for collecting the ambient sounds to which they are exposed and extract special information from them. This information, known as “sound prints”, may be compressed and stored locally for subsequent transfer to a data collection center, or it may be transferred in real time—depending on the availability of a communication link and the amount of battery power one prefers to commit to the information transfer function. Transfer can occur either by sending the memory media that contain the recordings or over a wired or wireless connection to a computer of the data collection center, typically a server which is capable of storing large amounts of data and is provided with suitable processing software. The data collection center also records continuously all the radio or television stations to be monitored, making them available on its computer. In order to define which radio or television stations have been heard during the day by a panel member, each sound print detected by a MediaWatch type meter at a certain instant in time is compared with the recordings of each of the selected radio and television stations, only as regards a small time interval around the instant being considered, in order to identify the station, if any, to which the meter was exposed at that time. To minimize the possibility of achieving false positives and false negatives, the assessment may be performed on a set of consecutive sound prints. An example of a highly reliable and robust sound print matching technique of the aforementioned type is described in U.S. Published Patent Application No. US2006.0262887 filed by Lombardo et al. on May 11, 2006 and entitled METHOD AND SYSTEM FOR COMPARING AUDIO SIGNALS AND IDENTIFYING AN AUDIO SOURCE, the entirety of which is incorporated expressly herein by reference. The aforementioned technique may be readily adapted to a portable user appliance as portable user appliance 600, insofar as all of the components necessary for capturing, storing, and transferring the sound print samples to a centralized storage facility are present.

An alternative methodology for capturing audio information needed to identify the media to which a single source panel member has been exposed involves sampling an audio component of media and recovering a signature from the monitored signal which distinctly and uniquely identifies the media. It will be readily appreciated that a portable user appliance operating in such a conventional manner using such available components as the microphone, processor, memory and communication interface will provide a comparable ability to identify the media to which participants are exposed and, therefore, may be used instead of the above-described sound-print matching technique.

A second program, adapted to be executed by the processor of the portable user appliance in accordance with an illustrative embodiment of the present invention, is adapted to capture, process and store in memory UPC code information of products purchased by the member of the single source panel to whom portable user appliance 600 is assigned. The second program is configured to process an image of a UPC code captured by the member of a single source panel using camera 612 of portable user appliance 600. The processing may include actual recognition and/or extraction of the UPC code information from the image or simply compression and storage of the captured image itself for subsequent transfer to a central facility where such recognition and/or extraction can be performed. In accordance with an especially preferred embodiment of the present invention, the second program executed by portable user appliance 600 is configured to utilize GPS data (which is now commonly available on most mobile telephones) or location data derived from signals exchanged between the device and nodes of a communication network so as to initiate a request that the panel member confirm a detected store location as the location of the product purchase. The request may be in the form of a pop-up screen visually presented to the panel member via display 604 or an audible message audibly reproduced by speaker 607. Likewise, the response of the panel member can be supplied via an alphanumeric keypad, touch screen input, or via utterance captured by microphone 606, depending upon which of these are incorporated into user interface 614.

Alongside radio and TV measurement, devices such as the above-described Telecontrol MediaWatch are also used to measure print media or billboards: via a display, the watch wearer can save data on newspapers and magazines read in the watch and, via an RF signal, the watch recognizes when its wearer has gone past a poster. Such functionality can also be performed by the portable user appliance 600. However, in accordance with an especially preferred embodiment of the present invention, the UPC code information of magazines and periodicals are scanned in the same way as products that a panel member has purchased. Optionally, in response to scanning of a UPC code corresponding to a magazine, newspaper, or other publication, a panel member can be prompted to answer one or more questions such, for example, asking the panel member to select, from a list, an identification of any advertisers whose products were advertised in the publication. Such an operation, of course, requires a real time interface to a server able to receive the scanned UPC information and return the query for display or audible reproduction to the panel member. It suffices to say that such a functionality is neither contemplated, nor taught or suggested by any prior art market measurement technique. It should be emphasized, however, that if the requests are too lengthy or too frequent, participants may become less enthusiastic about their participation so care should be taken to minimize intrusion and, if possible, to provide suitable incentives for continued participation.

Using GPS tracking of the portable user appliance associated with a panel member, it is further possible to acquire a list of billboards within the immediate proximity of a travel route being or recently traversed by the panel member (assuming that a master list of billboards in the geographic region of the panel member(s) has already been established) to which exposure of the panel member might be inferred. At some predetermined interval, the portable user appliance may audibly reproduce or display a request that the panel member identify billboards seen on a particular day from, for example, a list that includes some billboards that were NOT present along the route. Insofar as an audible reproduction of the message might be deemed least intrusive, by most, it would most likely be a preferred means of delivering such survey question(s). It suffices to say that a device which combines both a microphone, speaker, display, location detection capability, a wireless communication interface capable of real-time communications, bar code scanning, and media monitoring capabilities possesses attributes which have heretofore been unexploited and which, when used in accordance with the teachings of the present invention, will address a large number of unmet needs in the field of market research—particularly, but not limited to, the gathering of information from participants in a single source consumer panel.

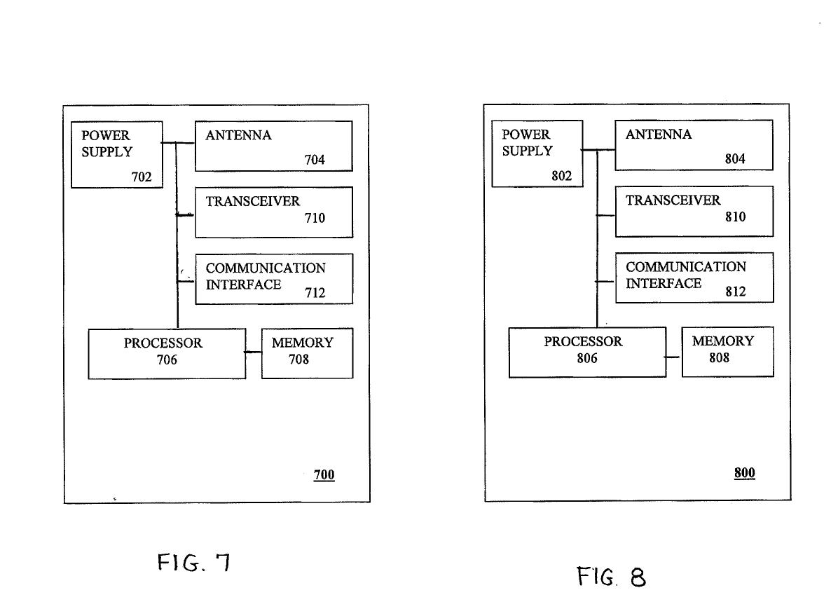

In any event, and with reference now to FIG. 7, there is shown a block diagram depicting an optional adjunct device 700 for distinguishing between two or more users of the same personal computer (not shown) within a household to which at least one panel member belongs. As noted earlier, at least one personal computer within every household to which one or more participants belong is configured to execute an online web tracking application that accumulates information relating to websites visited and/or products purchased by panel members. Various means may be employed to determine whether and which participant is using a household personal computer at a given time. The most simple means for ascertaining this information is to employ a simple “log-in” or authentication procedure after any period of inactivity exceeding a defined interval (e.g., 15 minutes). Unfortunately, this relatively simple authentication procedure is subject to error when a panel member leaves the personal computer and he or she is replaced by another panel member or even a non-participant, before expiration of the defined interval. Adjunct device 700 enables a determination to be made as to whether a proximity threshold between the portable user appliance and the adjunct device (as a proxy for the accessed personal computer) has been exceeded, thereby providing one way to address this shortcoming, and may be used as a replacement for or as a supplement to the aforementioned log-in scheme. As used herein the phrase “exceeding of a proximity threshold” is intended to encompass (1) falling below a minimum distance between a personal computer/adjunct device pair and the portable user appliance that would support an inference that the associated panel member is accessing the personal computer, (2) moving beyond a maximum distance between a personal computer/adjunct device pair and the portable user appliance that would support an inference that the associated panel member is no longer accessing the personal computer, and (3) a measurement corresponding to either the minimum or minimum distances.

In any event, and with continued reference to FIG. 7, it will be seen that adjunct device 700 includes a power supply 702, an antenna 704, a processor 706, a memory 708, a transceiver 710 operative to exchange signals wirelessly with portable user appliances associated with corresponding panel member within the household, and a communication interface 712 configured to communicate with a personal computer (not shown). In accordance with an illustrative embodiment, a transmitter portion of adjunct device 700 emits a beacon signal at periodic intervals. When within range of this signal, each portable user appliance responds to the beacon signal by transmitting a packet (e.g., an IEEE 802.11 packet) or bluetooth signal that reports the strength of the beacon signal received by that portable user appliance. An exemplary open source application for monitoring signal strength (as measured in dB) of nearby 802.11 transmitters is known as “WiFi Analyzer” and is available for smartphones using the Google Android operating system. The portable user appliance reporting the greatest signal strength may be reliably deemed to be the closest to a personal computer associated with adjunct device 700 (provided the two are reasonably close together). Packets transmitted by a portable user appliance are received by a receiver portion of transceiver 706 and then either supplied unchanged by communication interface 712 to the personal computer for extraction of proximity measurement information from the packets or they are processed by the adjunct device 700 to extract the information.

The personal computer executing the online activity tracking program can react to the extracted proximity information by, for example, displaying a request for a currently logged-in panel member to re-enter a password when the portable user appliance of that panel member shows a change in proximity or that the portable user appliance of a second panel member has moved closer to the adjunct device. It will be readily appreciated by those skilled in the art, that any suitable technique for measuring the proximity of the portable user appliance and adjunct device, or making use of this information, may be employed without departing from the spirit and scope of the present invention. By way of alternative example, the portable user appliance might simply store measurements of beacon signal strength at regular intervals, along with associated time-stamps, and then transmit the time-stamped signal measurement entries to a central server for correlation to time stamped web tracking data received from the associated personal computer. A program executing at the central server would be adapted to correlate reported web browsing and purchasing activity to the closest portable user appliance and the corresponding panel member to which that portable user appliance is assigned.

With reference now to FIG. 8, there is shown block diagram depicting an adjunct device 800 which can be associated with one or more media access stations (e.g., a television, home entertainment system, satellite or broadcast radio receiver or any other device used to provide access to media. As seen in FIG. 8, adjunct device 800 includes a power supply 802, an antenna 804, a processor 806, a memory 808, a transceiver 810 operative to exchange signals wirelessly with portable user appliances associated with corresponding panel member within the household, and a communication interface 812 configured to communicate with a personal computer (not shown). In accordance with an illustrative embodiment, a transmitter portion of adjunct device 800 emits a beacon signal at periodic intervals and facilitates proximity determinations in a manner very similar to the operation of adjunct device 700 described above. Adjunct device 800 is adapted to serve as an access point for one or more portable user appliances within a household, and includes the ability to orchestrate a hand-off of one or more market research functions from the portable access appliances in order to save power, free up resources, and otherwise make it easier for the panel members to use a portable user appliance as appliance 600 just as they would any other mobile terminal.

To this end, memory 808 may contains one or more of the same programs as are stored in memory 610. One function which may be handed-off to adjunct device 800 when the portable user appliance (and corresponding panel member) is close enough to a media access station/adjunct device pair as to be exposed to the media being audibly reproduced or otherwise delivered by the media access station. Thus, while a proximity threshold is exceeded, performance of the audio sampling function is suspended at the nearby portable user appliance and a program stored in memory 808 of device 800 is executed by processor 806 to perform the same or an equivalent function. By equivalent function, the inventors herein intend that the proximity detecting functionality performed by adjunct device 800 might be merged with a conventional set top box media monitoring system, such that during the time a hand-off is in effect, the media monitoring algorithms and techniques associated with the set top box system take precedence. An illustrative example of a commercially available set top box media monitoring system which may incorporate the proximity monitoring functionality of adjunct device 800 in accordance with the teachings of the present invention is the TC VIII, which is supplied by GfK Telecontrol AG of Switzerland. Models of the TC VIII identify analog television channels using frequency measurement with a measuring adapter or using injection technology, which measures a TV station's frequency. Digital television is measured using screen interface processing or a software solution that interprets the data from a digital receiving set. It will thus be readily appreciated by those skilled in the art that during the period of a hand-off, a different monitoring technique may be applied to the media and a different component of the media (video vs. audio) may be monitored. It suffices to say that during the period of the handoff, more processing resources of portable user appliance 600 are available to the panel member and/or a substantial savings in power consumption can be realized.

By including a communication interface as interface 812, it is further possible to accommodate the transfer of information stored in memory 610 of portable user appliance 600. By way of example, previously stored UPC and other product purchase information, previously stored media samples (or information extracted therefrom), and the like may be transferred quickly and with minimal use of power to the adjunct device 800, as opposed to requiring to establishing a link between a portable user appliance and the central facility (as depicted in FIG. 5).

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

1. A method for improving market research to understand effectiveness of an integrated advertising campaign, the method comprising:
providing each of a plurality of panel members with a portable user appliance, each portable user appliance having
a scanning module for scanning and storing a UPC code for each product purchased by a corresponding panel member,
a processor,
a memory operatively associated with the processor for storing scanned UPC codes and other product purchase information,
a user-interface,
a microphone, and
a communication interface operative to transfer information stored in the memory for delivery to a central facility, wherein each said portable user appliance is operable according to a first mode of operation to scan and store in memory UPC code of purchases made by a corresponding panel member and wherein each said portable user appliance is operable according to a second mode of operation to monitor an audio component of media to which a corresponding panel member is being exposed;
in a first collecting step, receiving UPC code information corresponding to purchases made by a first panel member and uploaded from a first portable user appliance associated with the first panel member;
in a first associating step, associating UPC code information, received during the first collecting step, in association with at least one of a demographic profile and an identity of the first panel member;
in a second collecting step, receiving information from which an identity of media monitored by the first portable user appliance and to which the first panel member was exposed can be determined;
in a second associating step, associating at least one of the demographic profile and identity of the first panel member with advertisements delivered via media to which the first panel member was exposed;
in a third collecting step, receiving from a personal computer used by the first panel member a transmission from which at least one of an advertisement seen on a web page visited by the first panel member and a product purchased online by the first panel member can be identified; and
in a third associating step, associating at least one of the demographic profile and identify of the first panel member with product purchase or web page visit information collected during the third collecting step.

2. The method of claim 1, further including
receiving UPC code information corresponding to purchases made by a second panel member and uploaded from a second portable user appliance associated with the second panel member;
associating UPC code information obtained from the second portable user appliance with at least one of a demographic profile and an identity of the second panel member;
receiving information from which an identity of media monitored by the second portable user appliance and to which the second panel member was exposed can be determined;
associating at least one of the demographic profile and identity of the second panel member with advertisements delivered via media to which the second panel member was exposed;
receiving from a personal computer used by the second panel member a transmission from which at least one of an advertisement seen on a web page visited by the second panel member and a product purchased online by the second panel member can be identified; and
associating at least one of the demographic profile and identify of the second panel member with product purchase or web page visit information collected from the personal computer used by the second panel member.

3. The method of claim 2, wherein the first panel member and the second panel member belong to a single household.

4. The method of claim 3, wherein a personal computer accessed by the first panel member and the second panel member is configured to determine which of the first and second portable user appliances is closest, and wherein said method further comprises a step of associating a period of online activity with a portable user appliance and associated panel member determined to be closest.

5. The method of claim 4, wherein each of said first and second portable user appliances is a mobile telephone having stored in memory a program executable by the processor to monitor a beacon signal transmitted by an adjunct device, and wherein said method further comprises a step of determining which of the first and second portable user appliances is closest based on which of the portable user appliances reports a higher received beacon signal level to the adjunct device.

6. The method of claim 2, wherein at least one of the first and second portable user appliances is a mobile telephone having stored in memory a program executable by the processor to monitor a beacon signal transmitted by an adjunct device, and to transmit an information signal representative of a received strength of the beacon signal to an adjunct device whereby a proximity of a portable user appliance relative to the adjunct device can be determined.

7. The method of claim 6, wherein an adjunct device is operatively associated with a first personal computer, and wherein said method further includes a step of determining which of the first and second portable user appliances is closest to the first personal computer and displaying an identity confirmation request in response to the determining step.

8. The method of claim 6, wherein the scanning module of each of the first and second portable user appliances includes a built-in camera and a second program stored in memory and executable by the processor to process an image of a UPC code captured by the camera to obtain UPC code information and wherein said method further includes a step of transmitting a signal representative of obtained UPC code information to the adjunct device for subsequent transfer to a central facility during the first collecting step.

9. The method of claim 8, further including a step of transmitting to the adjunct device a signal representative of media previously monitored and stored by the first portable user appliance.

10. The method of claim 9, further including a step of transmitting to the adjunct device a signal representative of media previously monitored by the second portable user appliance.

11. The method of claim 9, further including a step of suspending monitoring of media by the first portable user appliance based on a proximity determination made by the adjunct device, and a step of performing monitoring of media by the adjunct device until a second proximity determination indicates that the first portable user appliance is too far away for the corresponding first panel member to be exposed to the media.

12. The method of claim 6, further including a step of transmitting to the adjunct device a signal representative of media previously monitored and stored by the first portable user appliance.

13. The method of claim 12, further including a step of transmitting to the adjunct device a signal representative of media previously monitored by the second portable user appliance.

14. The method of claim 12, further including a step of suspending monitoring of media by the first portable user appliance based on a proximity determination made by the adjunct device, and a step of performing monitoring of media by the adjunct device until a second proximity determination indicates that the first portable user appliance is too far away for the corresponding first panel member to be exposed to the media.

15. The method of claim 1, wherein the scanning module of the first portable user appliance includes a built-in camera and a program stored in memory and executable by the processor to process an image of a UPC code captured by the camera to obtain UPC code information and wherein said method further includes a step of transmitting a signal representative of obtained UPC code information to a central facility during the first collecting step.

16. A portable user appliance for collecting and transferring product purchase and media exposure data, comprising:
a scanning module for scanning and storing a UPC code of products purchased by a corresponding panel member;
a battery;
a display;
a processor;
a memory for storing scanned UPC codes and other product purchase information;
a user-interface;
a microphone; and
a communication interface operative to transfer information stored in the memory for delivery to a central facility, wherein said portable user appliance is operative to monitor an audio portion of media to which a panel member is exposed.

17. An adjunct device for use with at least one portable user appliance adapted to at least one of scan UPC codes of products purchased by a corresponding consumer and to periodically sample an audio portion of media, to which a panel member is being exposed, using a microphone and software executed by an onboard processor, the adjunct device comprising:
a memory;
a processor adapted to execute a program for monitoring at least one of an audio component and a video component of a media broadcast and
a receiver operative to receive a signal from the at least one portable user appliance and to derive therefrom an indication of proximity between the adjunct device and said at least one portable user appliance, wherein said adjunct device is responsive to execute the program for monitoring after detecting that the at least one portable user appliance exceeds a defined proximity threshold.

18. The adjunct device of claim 17, further including a transmitter operative to emit a periodic beacon signal of substantially constant signal strength during a broadcast interval, and wherein signals received from the at least one portable user appliance are representative of a measure of received beacon signal strength at a location of the at least one portable user appliance.

19. The adjunct device of claim 17, wherein said adjunct device further includes a communication interface, said adjunct device being operative to periodically sample a media broadcast after detecting that said proximity threshold is exceeded and to transmit, to a central facility, information from which an identity of advertising messages presented by the media broadcast to a panel member associated with the corresponding portable user appliance can be derived.

20. The adjunct device of claim 19, wherein said adjunct device further includes a microphone for periodically sampling an audio component of the media broadcast after the proximity threshold is exceeded, whereby an identity of an advertising message presented audibly by the media broadcast to a panel member associated with the corresponding portable user appliance can be derived.

21. The adjunct device of claim 20, wherein said adjunct device is further operative to transmit UPC code and any other product purchase information stored within the portable user appliance to a central facility.

22. The adjunct device of claim 17, wherein said adjunct device is further operative to transmit UPC code and any other product purchase information stored within the portable user appliance to a central facility.

23. An adjunct device for use with a personal computer executing an online web browsing tracking application and accessible to at least one panel member within a household, the adjunct device being further configured for use with a portable user appliance associated with the at least one panel member and adapted to at least one of scan and store UPC codes of products purchased by the at least one panel member and to periodically sample an audio portion of a media broadcast using a microphone and software executed by an onboard processor, the adjunct device comprising:
a memory; and
a receiver operative to receive a signal from the at least one portable user appliance and to derive therefrom an indication of proximity between the adjunct device and said at least one portable user appliance, wherein said adjunct device is responsive to execute the program for monitoring when the at least one portable user appliance exceeds a defined proximity threshold.

24. The adjunct device of claim 23, further including a transmitter operative to emit a periodic beacon signal of substantially constant signal strength during a broadcast interval, and wherein signals received from the at least one portable user appliance are representative of a measure of received beacon signal strength at a location of the at least one portable user appliance.

25. The adjunct device of claim 24, wherein said adjunct device further includes a communication interface, said adjunct device being operative to periodically sample a media broadcast when said proximity threshold is exceeded and to transmit, to a central facility, information from which an identity of advertising messages presented by the media broadcast to a panel member associated with the corresponding portable user appliance can be derived.

26. The adjunct device of claim 25, wherein said adjunct device further includes a microphone for periodically sampling an audio component of the media broadcast, whereby an identity of an advertising message presented audibly by the media broadcast to a panel member associated with the corresponding portable user appliance can be derived.

27. A method, comprising
receiving respective UPC code information corresponding to purchases made by first and second panel members;
associating the respective UPC code information received with at least one of a demographic profile and an identity of a corresponding one of the first and second panel members;
receiving information from which an identity of media monitored by a portable user appliance and to which at least one of the first and second panel members was exposed can be determined;
associating at least one of the demographic profile and identity of at least one of the first and second panel members with advertisements delivered via media to which the first or second panel member was exposed;
receiving from a personal computer used by at least one of the first and second panel members a transmission from which at least one of an advertisement seen on a web page visited by the at least one of the first and second panel members and a product purchased online by the at least one of the first and second panel members can be identified; and
associating at least one of the demographic profile and identify of a panel member with product purchase or web page visit information received from the personal computer.
